(19) United States
(12) Patent Application Publication
(10) Pub. No.: US 2023/0188968 A1
(43) Pub. Date: Jun. 15, 2023

(54) Context-Enhanced Emergency Service

(71) Applicant: AT&T Intellectual Property I, L.P., Atlanta, GA (US)

(72) Inventors: Amee Sheth, Brick, NJ (US); James Gordon Beattie, Bergenfield, NJ (US); Donald Sorkin, West Windsor, NJ (US)

(73) Assignee: AT&T Intellectual Property I, L.P., Atlanta, GA (US)

(21) Appl. No.: 17/551,383

(22) Filed: Dec. 15, 2021

(51) Int. Cl. H04W 4/90; H04M 1/72418; H04W 4/02; H04W 4/38

(52) U.S. Cl. CPC H04W 4/90; H04M 1/72418; H04W 4/025; H04W 4/38

(57) ABSTRACT

Concepts and technologies disclosed herein are directed to context-enhanced emergency service. According to one aspect disclosed herein, a victim device can execute a victim emergency application. The victim emergency application can preemptively collect emergency event data associated with a victim of an emergency event before the emergency event occurs. The victim device can communicate the emergency event data towards an emergency network. In response to the emergency event, the victim device can initiate an emergency call directed to the emergency network, and subsequently the emergency call can fail. Since the emergency network has the emergency event data preemptively collected by the victim emergency application, emergency personnel is more likely to be able to help the victim even after the emergency call fails.

### BACKGROUND

In the United States, the telephone number “9-1-1” is the designated universal emergency number for requesting emergency assistance. Emergency 9-1-1 (“E911”) service provides fast and easy access to emergency services via a public safety answering point (“PSAP”). A PSAP is a call center responsible for answering calls to an emergency telephone number and for dispatching emergency services such as police, firefighters, and ambulance services. E911 service has evolved and now allows text and video in addition to voice calls. Moreover, the E911 infrastructure can support national internetworking of emergency service, including the ability to transfer emergency calls to other PSAPs.

PSAPs can identify caller locations for landline and mobile calls. For a landline E911 call, the PSAP utilizes the name, address, and telephone number associated with the landline telephone used to make the call. For a mobile E911 call, the PSAP utilizes the address of a base station serving the mobile device that originated the call, the telephone number associated with the mobile device, and the estimated location of the mobile device (e.g., via Global Positioning System “GPS” and/or cellular triangulation). In recent years, the use of mobile E911 calls has significantly increased due, in part, to the overall increase in mobile device use and the transition from landline to mobile telecommunications networks.

A common E911 scenario is a calling party placing a mobile E911 call and being unable to maintain the call due to device issues, battery conditions, network conditions, environmental conditions, the behavior of another person (e.g., the calling party is being physically assaulted, a vehicle accident, or for some other reason). When the mobile E911 call fails, the dispatch operator in the PSAP attempts to call back the calling party. The calling party may no longer be able to answer because they or their mobile device has been compromised, at which point the dispatch operator can initiate a manual trace using tools or communications with telecommunications service providers. This can introduce undue delay and may lead to the loss of life and/or property.

### SUMMARY

Concepts and technologies disclosed herein are directed to context-enhanced emergency service. According to one aspect disclosed herein, a victim device can execute a victim emergency application. The victim emergency application can preemptively collect emergency event data associated with a victim of an emergency event before the emergency event occurs. The victim device can communicate the emergency event data towards an emergency network. In response to the emergency event, the victim device can initiate an emergency call directed to the emergency network, and subsequently the emergency call can fail. Since the emergency network has the emergency event data preemptively collected by the victim emergency application, emergency personnel is more likely to be able to help the victim even after the emergency call fails.

The emergency event data can include victim data associated with the victim. The victim data can include personal identifying data of the victim, such as name, nickname, physical address, telephone number, email address, medical history (e.g., medications, allergies, surgeries, and other medical data), biometric data, combinations thereof, and/or the like. The emergency event data can alternatively or additionally include any data associated with the victim device. For example, the victim device data can include location, make, model, International Mobile Equipment Identity (“IMEI”), Equipment Serial Number (“ESN”), Mobile Equipment Identifier (“MEID”), Subscriber Identity Module (“SIM”), Mobile Serial Number (“MSN”), hardware specifications (e.g., processor type, memory capacity, storage capacity, and the like), software specifications (e.g., operating system and software applications installed), firmware specifications (e.g., current firmware version), radio specifications, communication capabilities (e.g., video call, VoIP, SMS, MMS, email, and the like), battery condition (e.g., state of charge), any other data associated with the victim device, combinations thereof, and/or the like. The victim device data can alternatively or additionally include device usage data such as, for example, call history, message history (e.g., IMESSAGE, SMS, MIMS, and the like), emergency contact information, contact list/address book, application usage, social media activity, combinations thereof, and/or the like.

In some embodiments, the victim device can generate and broadcast one or more emergency assistance messages to at least one additional device, such as, for example, one or more bystander devices, one or more Internet of Things (“IoT”) devices, and/or one or more landline devices. The emergency assistance messages may be broadcast via BLUETOOTH or another short-range radio communications technology. Other technologies such as WIFI are also contemplated. The emergency assistant message(s) can prompt the additional device(s) to provide additional emergency event data to the emergency network. This emergency event data can include any data associated with the bystander(s) and/or the bystander device(s) the same as or similar to the type of data described above for the victim data and the victim device data. This emergency event data can include landline data such as telephone number and addresses of the landline device(s) that are within a specified range of the emergency event. This emergency event data can include IoT data such as audio data, still image data, video data, and/or environmental data such as temperature, moisture/humidity, barometric pressure, solar radiation, road conditions, wind speed and direction, light, gas concentration, fire, water level, snow level, and any other data about the environment in or around where the emergency event occurred. The IoT data can include location data associated with the IoT device(s) (e.g., address or latitude/longitude coordinates).

The emergency event data can alternatively or additionally include other data source data obtained from one or more other data sources such as news outlets, websites, and/or other sources of data. The emergency event data can alternatively or additionally include network condition data that is representative of one or more operational aspects (e.g., signal strength, peak usage, outages, bandwidth, and the like) of one or more networks.

According to another aspect disclosed herein, an emergency event data aggregator can obtain the emergency event data from the victim device, and may also obtain the emergency event data from one or more additional devices such as those described above. The emergency event data aggregator can determine an emergency context based, at least in part, upon the emergency event data. The emergency context can be used by the emergency personnel to assist the victim in response to the emergency event. The emergency context can identify a location of the emergency event, a type of the emergency event, a priority of the response needed (e.g., life-threatening vs. non-life-threatening) for handling the emergency event, and an identity of the victim (if available). The emergency event data aggregator can utilize artificial intelligence to determine the probability of each component of the emergency context being a certain value. For example, a probability that the location of the victim is a specific location based upon the emergency event data that is related to location. The emergency event data aggregator can forward the emergency context to a PSAP that is determined based, at least in part, upon the emergency event data to be correct for the location of the victim. The emergency personnel at the PSAP (e.g., a PSAP dispatcher) can respond to the emergency event based upon the emergency context.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment in which the concept and technologies disclosed herein can be implemented.

FIG. 2 is a flow diagram illustrating a method for providing a context-enhanced emergency service, according to an illustrated embodiment.

FIG. 3 is a block diagram illustrating an example mobile device, according to an illustrative embodiment.

FIG. 4 is a block diagram illustrating an example computer system capable of implementing aspects of the embodiments presented herein.

FIG. 5 is a diagram illustrating a network, according to an illustrative embodiment.

FIG. 6 is a diagram illustrating a virtualized cloud architecture capable of implementing aspects of the embodiments presented herein.

FIG. 7 is a diagram illustrating machine learning system capable of implemented aspects of the embodiments presented herein.

FIG. 8 is a block diagram illustrating aspects of an Internet of Things (“IoT”) sensor device and components thereof capable of implementing aspects of the embodiments presented herein.

### DETAILED DESCRIPTION

The concepts and technologies disclosed herein are directed to context-enhanced emergency service. According to one aspect disclosed herein, in advance of a call to the PSAP, a device associated with the calling party can communicate a location history (e.g., within the last X minutes), a call history, a text history, or other device history that may be useful to the PSAP personnel and/or first responders in locating the calling party during an emergency event. In this manner, concerns, threats, or other challenges to the calling party can be shared in advance of the call to the PSAP. The release of this information can be automatic or manually triggered by the calling party. This information can be communicated via text message, email, or an automated web posting to a well-known address such as, for example, “E911,” “911,” “E911@psap.gov,” “911@psap.gov,” “http://e911.psap.gov,” or “http://911.psap.gov,” which also could be used to automatically create a voice and/or video path.

The disclosed solution provides the PSAP with a more precise location of the calling party, even if the calling party has lost their location lock (e.g., GPS). A timestamped location history can provide a suitable starting point for the PSAP personnel to initiate a caller location process, while also gathering contacts and even direct information from text messages and recorded call history or call recordings for use by the PSAP personnel and/or First Responders. This is a significant improvement over simple cell site triangulation done on an emergency basis in cooperation with telephone operating companies. This would address the scenario where cellular calls are routed to an incorrect Network Response Center due to the calling party's proximity to a cell tower located closer to a different PSAP causing an incorrect Automatic Location Identification (“ALI”) to be provided. It would preclude these calls from then needing to be forwarded to that correct PSAP.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of concepts and technologies for providing a context-enhanced emergency service will be described.

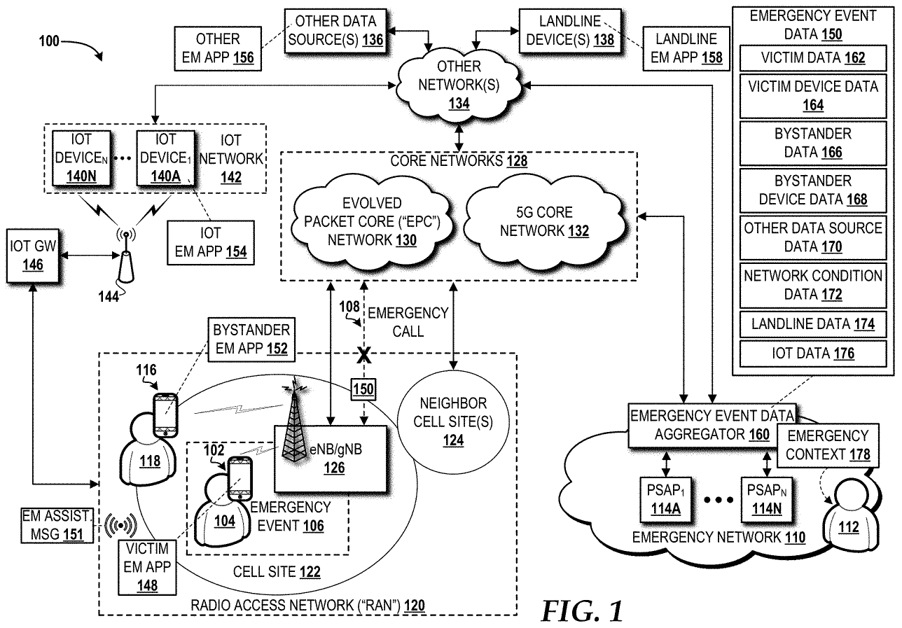

Referring now to FIG. 1, an illustrative operating environment 100 in which the concepts and technologies disclosed herein can be implemented will be described. The operating environment 100 includes a victim device 102 associated with a victim 104 of an emergency event 106. The victim 104 can utilize the victim device 102 to initiate an emergency call 108 (e.g., E911 call) directed towards an emergency network 110 in an attempt to obtain emergency assistance from emergency personnel 112 such as PSAP personnel (e.g., emergency dispatcher) associated with one or more PSAPs 114A-114N, first responders (e.g., police, firemen, paramedics, and the like), and/or the like in response to the emergency event 106. The emergency event 106 can be any bona fide emergency or any situation that the victim 104 perceives to be an emergency (as is typical of 9-1-1 service). By way of example, and not limitation, the emergency event 106 can be any serious situation where a law enforcement officer, fire fighter, or emergency medical help is needed right away and an emergency call or other communication with the National Emergency Number Association (“NENA”; also known as The 9-1-1 Association) is warranted. The emergency event 106 can be a real-world disaster and/or crisis such as, for example, a hurricane, tsunami, earthquake, tornado, other nature disaster, disease epidemic, and the like.

The operating environment 100 also includes a bystander device 116 associated with a bystander 118 of the victim 104, the emergency event 106, or both. The bystander 118 may be co-located with the victim 104 and/or the emergency event 106. The bystander 118 may otherwise perceive that the victim 104 is in need of assistance due to the emergency event 106 whether or not the emergency event is known to the bystander 118. The bystander 118 may be able to communicate in-person with the victim 104. The bystander 118 may have been informed (e.g., by another person or entity) of the victim 104 and/or the emergency event 106, or otherwise may have knowledge (e.g., via a news source) of the victim 104 and/or the emergency event 106.

The victim device 102 may be a cellular phone, a feature phone, a smartphone, a mobile computing device, a tablet computing device, a portable television, a portable video game console, or any other computing device that includes one or more radio access components that are capable of connecting to and communicating with one or more radio access networks (“RANs”) 120 via one or more radio access components. The bystander device 116 also may be a cellular phone, a feature phone, a smartphone, a mobile computing device, a tablet computing device, a portable television, a portable video game console, or any other computing device that includes one or more radio access components that are capable of connecting to and communicating with the RAN 120 via one or more radio access components. In some embodiments, the victim device 102 and/or the bystander device 116 can include an integrated or external radio access component that facilitates wireless communication with the RAN 120. The radio access component may be a cellular telephone that is in wired or wireless communication with the victim device 102 and/or the bystander device 116 to facilitate a tethered data connection to the RAN 120. Alternatively, the radio access component includes a wireless transceiver configured to send data to and receive data from the RAN 120 and a universal serial bus (“USB”) or another communication interface for connection to the victim device 102 and/or the bystander device 116 so as to enable tethering. In any case, the victim device 102 and the bystander device 116 can wirelessly communicate with the RAN 120 over a radio/air interface in accordance with one or more radio access technologies (“RATs”). The victim device 102 and the bystander device 116 may also initiate, receive, and maintain voice calls with one or more other voice-enabled telecommunications devices. The victim device 102 and the bystander device 116 may also exchange Short Message Service (“SMS”) messages, Multimedia Message Service (“MMS”) messages, email, and/or other messages with other systems, devices, and/or networks.

The RAN 120 can include one or more cell sites having the same or different cell sizes, which may be represented by different cell-types. The illustrated RAN 120 includes a cell site 122 and one or more neighbor cell sites 124. As used herein, a “cell” or “cell site” refers to a geographical area that is served by one or more base stations operating within an access network. In the illustrated example, the victim device 102 and the bystander device 116 are connected to the cell site 122 of the RAN 120 via a base station, such as a combined Evolved Node Base eNodeB (“eNB”) and mmWave Next Generation Node Base (“gNB”), which is shown as eNB/gNB 126. The eNB/gNB 126 and the RAN 120 can be configured in accordance with one or more 3GPP technical specifications for next generation (“5G”) RAN architecture, combined 4G/5G RAN architecture, legacy technologies, revisions thereof, combinations thereof, and/or the like.

The cells within the RAN 120 can include the same or different cell sizes, which may be represented by different cell-types. A cell-type can be associated with certain dimensional characteristics that define the effective radio range of a cell. Cell-types can include, but are not limited to, a macro cell-type, a metro cell-type, a femto cell-type, a pico cell-type, a micro cell-type, wireless local area network (“WLAN”) cell-type, and a white space network cell-type. A “small cell” cell-type is utilized herein to collectively refer to a group of cell-types that includes femto cell-type, pico cell-type, and micro cell-type, in general contrast to a macro cell-type, which offers a larger coverage area. Other cell-types, including proprietary cell-types and temporary cell-types are also contemplated. Although in the illustrated example, the victim device 102 and the bystander device 116 are shown as being in communication with one RAN (i.e., the RAN 120), the victim device 102 and the bystander device 116 may be in communication with any number of RANs and/or other access networks, including networks that incorporate collocated WWAN WI-FI and cellular technologies, and as such, the victim device 102 and the bystander device 116 can be dual-mode devices.

The RAN 120 can operate in accordance with one or more mobile telecommunications standards including, but not limited to, Global System for Mobile communications (“GSM”), Code Division Multiple Access (“CDMA”) ONE, CDMA2000, Universal Mobile Telecommunications System (“UMTS”), LTE, Worldwide Interoperability for Microwave Access (“WiMAX”), other current 3GPP cellular technologies, other future 3GPP cellular technologies, combinations thereof, and/or the like. The RAN 120 can utilize various channel access methods (which may or may not be used by the aforementioned standards), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like to provide a radio/air interface to the victim device 102 and the bystander device 116. Data communications can be provided in part by the RAN 120 using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. Moreover, the RAN 120 may be a GSM RAN (“GRAN”), a GSM EDGE RAN (“GERAN”), a UMTS Terrestrial Radio Access Network (“UTRAN”), an evolved U-TRAN (“E-UTRAN”), Next Generation RAN (“NG-RAN”), any combination thereof, and/or the like. In some embodiments, the RAN 120 is or includes one or more virtual RANs (“vRANs”).

The RAN 120 can operate in communication with one or more core networks 128, such as an Evolved Packet Core (“EPC”) network 130 and a 5G Core Network 132 in the illustrated example. The core networks 128 are, in turn, in communication with one or more other networks 134 such as one or more other public land mobile networks (“PLMNs”), one or more Public Switched Telephone Networks (“PSTNs”) one or more packet data networks (“PDNs”) (e.g., the Internet), other packet switched networks, other circuit switched networks, combinations thereof, and/or the like. The other network(s) 134 also can enable communications with one or more other data sources 136 (e.g., news outlets), one or more landline devices 138 (e.g., landline telephone), one or more Internet of Things (“IoT”) devices 140A-140N (hereinafter collectively and/or generically referred to as “IoT devices 140”) operating as part of an IoT network 142, and the emergency network 110.

The eNB/gNB 126 can connect to the EPC network 130 via an S1 interface, and more specifically to a mobility management entity (“MME”) (not shown) via an S1-MME, and to a serving gateway (“S-GW”) (not shown) via an S1-U interface. The EPC network 130 can include one or more MMES, one or more S-GW (which may be combined with one or more packet gateways (“P-GWs”), and one or more home subscriber servers (“HSS”). Although not shown in the illustrated example, the EPC network 130 can include these network elements and may additionally include other network elements not specifically mentioned herein. In general, the EPC network 130 can be established based upon 3GPP standards specifications.

The core network components of the EPC network 130 can be implemented as physical network functions (“PNFs”) having hardware and software components. The core network components of the EPC network 130 can additionally or alternatively be provided, at least in part, by virtual network functions (“VNFs”). For example, the core network components can be realized as VNFs that utilize a unified commercial-of-the-shelf (“COTS”) hardware and flexible resources shared model with the application software for the respective core network components running on one or more virtual machines (“VMs”). Moreover, the core network components can be embodied as VNFs in one or more VNF pools, each of which can include a plurality of VNFs providing a particular core network function.

An MME can be configured in accordance with 3GPP standards specifications and can perform operations to control signaling traffic related to mobility and security for access to the eNB portion of the eNB/gNB 126 via the S1-MME interface. The MME also can be in communication with an HSS via an S6a interface and a combined S/PGW via an S11 interface. These interfaces are defined as part of 3GPP standards specifications.

An SGW and a PGW can be configured in accordance with 3GPP standards specifications. The SGW can provide a point of interconnect between the radio-side (e.g., the eNB portion of the eNB/gNB 126) and the EPC network 130. The SGW can serve devices by routing incoming and outgoing IP packets between the eNB portion of the eNB/gNB 126 and the EPC network 130. The PGW interconnects the EPC network 130 to the other networks 134. The PGW routes IP packets to and from the other network(s) 134. The PGW also performs operations such as IP address/prefix allocation, policy control, and charging. The SGW and the PGW can be in communication with the MME via an S11 interface and with the other network(s) 134 via an SGi interface. These interfaces are defined as part of 3GPP standards specifications. A dedicated PGW may be used for emergency calls (e.g., VoLTE), such as the emergency call 108, directed to the emergency network 110.

An HSS can be configured in accordance with 3GPP standards specifications. The HSS is a database that contains user-related information for users of devices, such as the victim 104 that uses the victim device 102 and the bystander 118 that uses the bystander device 116. The HSS can provide support functions to the MME for mobility management, call and data session setup, user authentication, and access authorization.

At the edge of the EPC network 130, the MME and S-GW can be connected over the IP-based S1 interface to the eNB/gNB 126. The eNB and the gNB are logically different components that can communicate with each other via a standardized IP interface (i.e., the X2 interface). If the eNB and gNB are combined into a single hardware node, such as in the illustrated example, the X2 interface is an internal interface (or logical interface) between the two components.

The 5G core network 132 can include network functions that provide functionality similar to that of the EPC network 130 for LTE but for 5G technologies such as mmWave. For example, current 3GPP standards define a 5G core network architecture as having an access and mobility management function (“AMF”) that provides mobility management functionality similar to that of an MME in the EPC network 130; a session management function (“SMF”) that provides session management functionality similar to that of an MME and some of the S/P-GW functions, including IP address allocation, in the EPC network 130; an authentication server function (“AUSF”) managed subscriber authentication during registration or re-registration with the 5G core network 132; and user plane function (“UPF”) combines the user traffic transport functions previously performed by the S/P-GW in the EPC network 130, among others. While 3GPP has defined some of these network functions, these network functions may be split into greater granularity to perform specific functions, may be combined, and/or additional functions may be added by the time the mobile network operator deploys a live 5G network. As such, the 5G core network 132 is intended to encompass any and all 5G core network functions that are currently defined in technical specifications currently available and revisions thereof made in the future.

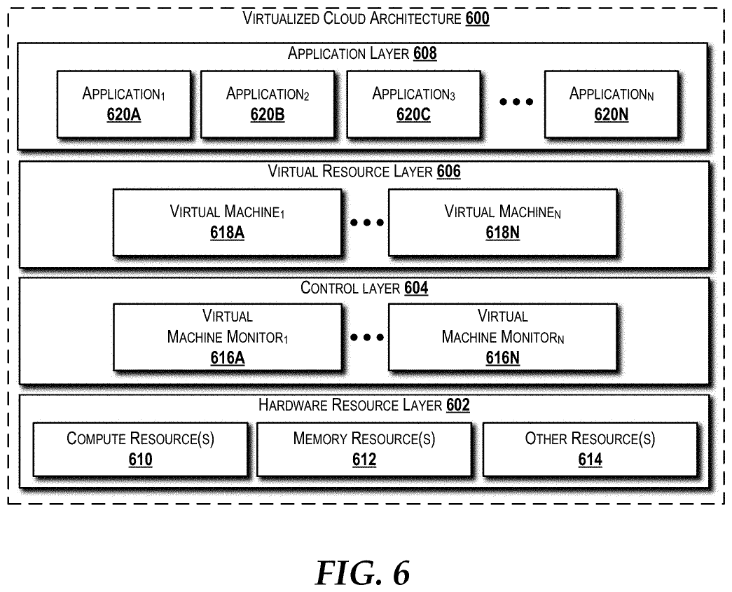

The core network elements of the core networks 128 can be implemented as PNFs having hardware and software components. The core network elements of the core networks 128 can additionally or alternatively be provided, at least in part, by VNFs supported by an underlying software-defined network (“SDN”) and network virtualization platform (“NVP”) architecture. For example, the core network elements can be realized as VNFs that utilize a unified commercial-of-the-shelf (“COTS”) hardware and flexible resources shared model with the application software for the respective core network components running on one or more virtual machines (“VMs”). Moreover, the core network elements can be embodied as VNFs in one or more VNF pools, each of which can include a plurality of VNFs providing a particular core network function. Similarly, elements of the RAN 120 can be implemented, at least in part, via VNFs. An example virtualized cloud architecture 600 that is capable of supporting virtualization technologies is described herein with reference to FIG. 6.

The IoT devices 140 can operate in communication with the RAN 120 directly or by way of a home eNB 144 (e.g., femtocell or small cell). For implementations in which an IoT device 140 connects to the home eNB 144 for access to the RAN 120, the home eNB 144 can route to the RAN 120 via an IoT gateway 146. The IoT GW 146 provides control capability to manage one or more home eNBs, such as the illustrated home eNB 144. The IoT GW 146 can be configured in accordance with 3GPP Technical Release 23.830 architecture. The IoT GW 146 can be configured in accordance with future 3GPP-defined architectures or can be configured in accordance with a proprietary architecture. Although the IoT GW 146 is shown as supporting only the home eNB 144, it is contemplated that the IoT GW 146 can support multiple home eNBs configured the same as or similar to the home eNB 144.

The victim device 102, the bystander device 116, and the IoT devices 140 each can be associated with an identity. The identity can include device identification information such as, for example, International Mobile Subscriber Identity (“IMSI”), a Mobile Station International Subscriber Directory Number (“MSISDN”), an International Mobile Equipment Identity (“IMEI”), or a combination of an IMSI and an IMEI. The device identification information, in some embodiments, can additionally include a device category that specifies a category to which the device belongs. The device identification information can identify the device as being either a device for a standard mobile telecommunications services such a voice and/or data. The device identification information can alternatively identify the device as an IoT or other IoT device. In some embodiments, the IoT devices 140 can be category 1 (“CAT1”), CAT0, CATM based machine-type communication devices, or some combination thereof.

The IoT devices 140 can be deployed across various industry segments and in locations, such as homes (e.g., single and multi-family), public transportation systems, roads, traffic lights, buildings, within the cell site 122, within the neighbor cell site(s) 124, or elsewhere. The IoT devices 140 are network addressable to facilitate interconnectivity for the exchange of data. The IoT devices 140 can be or can include any “thing” that can collect data and that is configured to be network addressable so as to connect to and communicate with one or more networks, such as the RAN 120 and/or the other network(s) 134, over which the IoT devices 140 can send data to other connected systems, device, and networks, including, for example, the PSAP(s) 114, the emergency network 110, the victim device 102, the bystander device 116, computers, smartphones, tablets, vehicles, other IoT devices, combinations thereof, and the like. The IoT devices 140 can be deployed for consumer use and/or business use, and can find application in many industry-specific use cases. For example, the IoT devices 140 may find at least partial application in the following industries: automotive, energy, healthcare, industrial, retail, and smart buildings/homes. In accordance with the concepts and technologies disclosed herein, the IoT devices 140 can find additional application in providing IoT data in association with the emergency event 106. Those skilled in the art will appreciate the applicability of IoT-solutions in other industries as well as consumer and business use cases. For this reason, the applications of the IoT devices 140 described herein are used merely to illustrate some examples and therefore should not be construed as being limiting in any way. Although in the illustrated example the IoT devices 140 are shown as being in communication with one RAN (i.e., the RAN 120), the IoT devices 140 may be in communication with any number of access networks, including networks that incorporate collocated WWAN WI-FI and cellular technologies, and as such, one or more of the IoT devices 140 can be dual-mode devices.

The PSAPs 114 are entities responsible for answering emergency messages and calls, such as the emergency call 108, to an emergency telephone number (e.g., 9-1-1), and for dispatching emergency services such as police, firefighters, and ambulance services. The PSAPs 114 can identify caller locations for landline calls and mobile calls. For landline calls, the PSAPs 114 can utilize the name, address, and telephone number associated with the landline telephone, such as the landline device 138, used to make the call. Traditionally, for mobile calls, the PSAP 114 utilizes the address of the base station serving the mobile device that originated the call, telephone number, and estimated location of the mobile device.

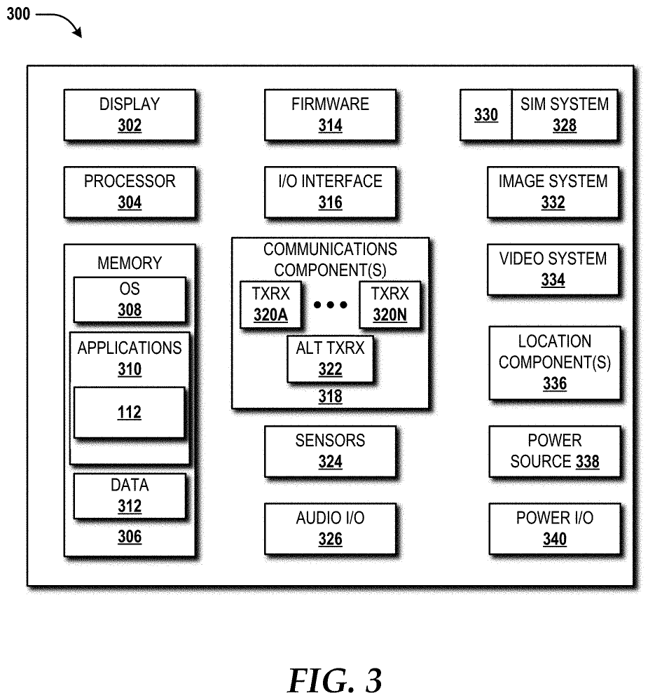

The victim device 102 can execute, via one or more processors (best shown in FIG. 3), a victim emergency application 148 that can monitor, collect, and distribute at least a portion of emergency event data 150 to the emergency network 110 before, during, and/or after the emergency event 106 ensues. In some embodiments, the victim emergency application 148 can provide the emergency event data 150 to the emergency network 110 before the emergency call 108 in preparation for the possibility that the emergency call 108 will fail. The victim emergency application 148 can provide the emergency event data 150 to the emergency network 1110 during or after the emergency call 108. The victim emergency application 148 can be programmed to provide emergency event data 150 on a periodic basis (e.g., hourly), in response to an automated trigger, or manually by the victim 104. The victim emergency application 148 can also generate and broadcast one or more emergency assistance messages 151 via BLUETOOTH or other short-range radio communications technology. In this manner other devices, such as the bystander device 116, the landline device 138, and/or the IoT device 140, can receive notification of the emergency event 106. The emergency assistance messages 151 may include at least a portion of the victim data 162 and/or the victim device data 164 and request that this data be provided to the emergency personnel 112. The emergency assistance messages 151 may prompt for calls to be placed to the emergency network 110 on behalf of the victim 104 and grant permission to share the victim data 162 and/or the victim device data 164 with the emergency personnel 112. The victim device 102 can utilize additional or alternative communications technologies to disseminate the emergency assistance message(s) 151. For example, the victim device 102 may broadcast the emergency assistance message(s) 151 via a local WIFI network to which the victim device 102 and other devices are connected.

Likewise, the bystander device 116 can execute, via one or more processors (best shown in FIG. 3), a bystander emergency application 152 that can also monitor, collect, and distribute at least a portion of the emergency event data 150 to the emergency network 110 before, during, and/or after the emergency event 106 ensues. In some embodiments, the bystander emergency application 152 can provide the emergency event data 150 to the emergency network 110 before the emergency call 108 made by the victim device 102 in preparation for the possibility that the emergency call 108 will fail. The bystander emergency application 152 can be programmed to provide emergency event data 150 to the emergency network 110 on a periodic basis (e.g., hourly), in response to an automated trigger, or manually by the bystander 118.

In addition to the victim emergency application 148 and the bystander emergency application 152, the IoT devices 140 can be configured to execute an IoT emergency application 154, the other data source(s) 136 can be configured to execute other emergency application 156, and the landline device(s) 138 can be configured to execute a landline emergency application 158. Each of these applications can be used to monitor, collect, and distribute at least a portion of the emergency event data 150 to the emergency network 110 before, during, and/or after the emergency event 106 ensues. In some embodiments, these applications can provide the emergency event data 150 to the emergency network 110 before the emergency call 108 made by the victim device 102 in preparation for the possibility that the emergency call 108 will fail.

As noted above, the emergency event data 150 can originate from multiple sources, including the victim device 102, the bystander device 116, the other data source(s) 136, the landline device(s) 138, and the IoT device(s) 140. The emergency network 110 can include an emergency event data aggregator 160 to collect the emergency event data 150 from these disparate sources, aggregate the emergency event data 150 for the emergency event 106, and provide the emergency event data 150 to the appropriate PSAP 114 for handling by the emergency personnel 112.

The emergency event data 150 can include any data associated with the victim 104 (shown as “victim data 162”). For example, the victim data 162 can include personal identifying data of the victim 104, such as name, nickname, physical address, telephone number, email address, medical history (e.g., medications, allergies, surgeries, and other medical data), biometric data, combinations thereof, and/or the like.

The emergency event data 150 can alternatively or additionally include any data associated with the victim device 102 (shown as “victim device data 164”). For example, the victim device data 164 can include location, make, model, International Mobile Equipment Identity (“IMEI”), Equipment Serial Number (“ESN”), Mobile Equipment Identifier (“MEID”), Subscriber Identity Module (“SIM”), Mobile Serial Number (“MSN”), hardware specifications (e.g., processor type, memory capacity, storage capacity, and the like), software specifications (e.g., operating system and software applications installed), firmware specifications (e.g., current firmware version), radio specifications, communication capabilities (e.g., video call, VoIP, SMS, MIMS, email, and the like), battery condition (e.g., state of charge), any other data associated with the victim device 102, combinations thereof, and/or the like. The victim device data 164 can alternatively or additionally include device usage data such as, for example, call history, message history (e.g., IMESSAGE, SMS, MIMS, and the like), emergency contact information, contact list/address book, application usage, social media activity, combinations thereof, and/or the like.

The emergency event data 150 can alternatively or additionally include any data associated with the bystander 118 (shown as “bystander data 166”). For example, the bystander data 166 can include personal identifying data such as name, nickname, physical address, telephone number, email address, medical history (e.g., medications, allergies, surgeries, and other medical data), biometric data, combinations thereof, and/or the like.

The emergency event data 150 can alternatively or additionally include any data associated with the bystander device 116 (shown as “bystander device data 168”). For example, the bystander device data 168 can include location, make, model, IMEI, ESN, MEID, SIM, MSN, hardware specifications (e.g., processor type, memory capacity, storage capacity, and the like), software specifications (e.g., operating system and software applications installed), firmware specifications (e.g., current firmware version), radio specifications, communication capabilities (e.g., video call, VoIP, SMS, MMS, email, and the like), battery condition (e.g., state of charge), any other data associated with the bystander device 116, combinations thereof, and/or the like. The bystander device data 168 can alternatively or additionally include device usage data such as, for example, call history, message history (e.g., IMESSAGE, SMS, MIMS, and the like), emergency contact information, contact list/address book, application usage, social media activity, combinations thereof, and/or the like.

The emergency event data 150 can alternatively or additionally include other data source data 170. The other data source(s) 136 can include news outlets, websites, and/or other sources of data. As such, the other data source data 170 can include data obtained from these sources. For example, a news story about the emergency event 106 may include information that is relevant to the victim 104 such as a last known location, family member contact information, and the like. In some instances, a news reporter may arrive at the location of the emergency event 106 prior to the emergency personnel 112.

The emergency event data 150 can alternatively or additionally include data (shown as “network condition data 172”) that is representative of one or more operational aspects (e.g., signal strength, peak usage, outages, bandwidth, and the like) of one or more networks, such as the RAN 120, the EPC network 130, the 5G core network 132, the other network(s) 134, the IoT network 142, the emergency network 110, or some combination thereof. The network condition data 172 can be obtained from network components, such as the eNB/gNB 126 and/or components of the core networks 128. The network condition data 172 can be obtained from network probes (not shown). The network condition data 172 can be obtained from the victim device 102 and/or the bystander device 116. The network condition data 172 can be obtained from a network operations center or similar entity.

The emergency event data 150 can alternatively or additionally include landline data 174. The landline data 174 can include telephone numbers and addresses of the landline device(s) 138 that are within a specified range of the emergency event 106. For example, a business that is near the emergency event 106 may have a landline device 138 that can be used as a backup in case the emergency call 108 fails.

The emergency event data 150 can alternatively or additionally include IoT data 176. The IoT data 176 can include audio data collected from a microphone of one or more of the IoT devices 140. The IoT data 176 can include still image and/or video data collected from a camera of one or more of the IoT devices 140. The IoT data 176 can include environmental data such as temperature, moisture/humidity, barometric pressure, solar radiation, road conditions, wind speed and direction, light, gas concentration, fire, water level, snow level, and any other data about the environment in or around where the emergency event 106 occurred. The IoT data 176 can include location data associated with the IoT devices 140 (e.g., address or latitude/longitude coordinates).

The emergency event data aggregator 160 can receive the emergency event data 150 via multiple communication methods including voice calls, video calls, text messages, IP messages, MMS messages, email, social media platform messages and posts, websites, device-to-device communication, any combination thereof, and the like. Moreover, the emergency event data aggregator 160 can communicate via the core network(s) 128 with the RAN 120 and/or via the other network(s) 134. As such, the emergency event data aggregator 160 is communication method and network agnostic.

The emergency event data aggregator 160 uses the emergency event data 150 to create an emergency context 178 for the emergency personnel 112 to use in assisting the victim 104 in response to the emergency event 106. The emergency context 178 can identify a location of the emergency event 106, a type of the emergency event 106, a priority of the response needed (e.g., life-threatening vs. non-life-threatening) for handling the emergency event 106, and an identity of the victim 104 (if available). The emergency event data aggregator 160 can utilize artificial intelligence to determine the probability of each component of the emergency context 178 being a certain value. For example, a probability that the location of the victim 104 is a specific location based upon the emergency event data 150 that is related to location.

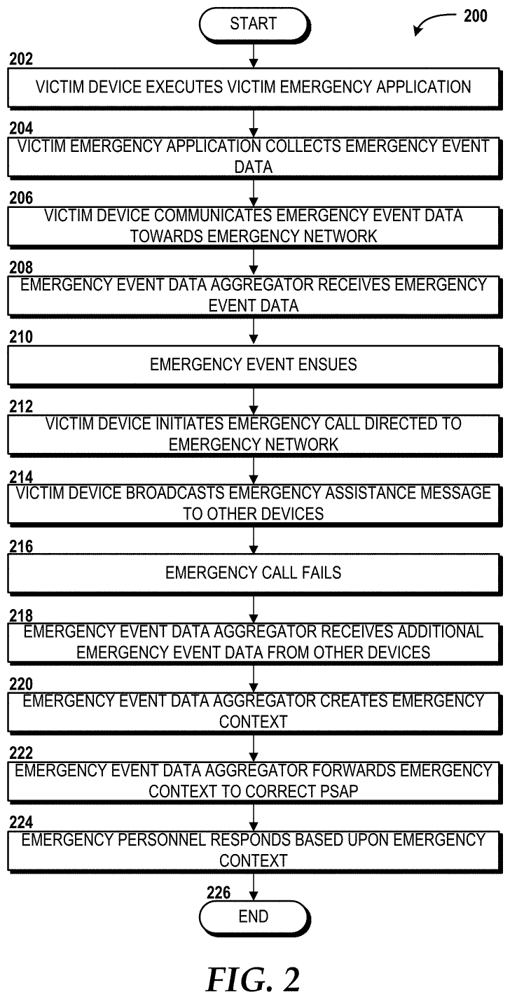

Turning now to FIG. 2, a flow diagram illustrating a method 200 for providing a context-enhanced emergency service will be described, according to an illustrative embodiment. The method 200 will be described with reference to FIG. 2 and additional reference to FIG. 1. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors disclosed herein to perform operations.

For purposes of illustrating and describing some of the concepts of the present disclosure, operations of the method 200 will be described as being performed, at least in part, by the victim emergency application 148 that can be executed by one or more processors of the victim device 102, the bystander emergency application 152 that can be executed by one or more processors of the bystander device 116, the other emergency application 156 that can be executed by one or more processors of the other data source(s) 136, the landline emergency application 158 that can be executed by one or more processors of the landline device(s) 138, the IoT emergency application 154 that can be execute by one or more processors of the IoT device(s) 140, the emergency event data aggregator, and/or other network elements, systems, and/or devices disclosed herein. It should be understood that additional and/or alternative network elements, systems, and/or device can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the victim device 102 executes the victim emergency application 148. The victim device 102 can execute the victim emergency application 148 in response to input from the victim 104. For example, the victim 104 may hold a physical button or combination of buttons to execute the victim emergency application 148. The victim device 102 can execute the victim emergency application 148 automatically based upon an external trigger. For example, the victim emergency application 148 may be executed in response to the victim device 102 entering a specific location (e.g., a geofenced location). The location may be specified by the victim 104 and/or another entity such as law enforcement, terrorist task force, disaster response team, or the like. Another external trigger may be received from another source, such as the bystander device 116, the IoT device 140, the other data source 136, the landline device 138, the emergency network 110, or the like. The victim emergency application 148 can be executed as a standalone application, as part of an operating system, or as part of a firmware of the victim device 102. The victim emergency application 148 can execute in the background or foreground.

From operation 202, the method 200 proceeds to operation 204. At operation 204, the victim emergency application 148 collects the emergency event data 150. The victim emergency application 148 can collect the emergency event data 150 on a periodic basis (e.g., hourly), in response to an automated trigger, or manually by the victim 104. It should be understood that operation 204 is performed prior to any emergency event 106 and is used in preparation for if an emergency event 106 occurs. However, the victim emergency application 148 may collect the emergency event data 150 during and/or after the emergency event 106 as well. In particular, the victim emergency application 148 can collect at least a portion of the victim data 162 and/or at least a portion of the victim device data 164. The victim emergency application 148 may collect other emergency event data 150, such as the bystander data 166, the bystander device data 168, the other data source data 170, the network condition data 172, the landline data 174, the IoT data 176, or a combination thereof. The victim data 162 can include personal identifying data of the victim 104, such as name, nickname, physical address, telephone number, email address, medical history (e.g., medications, allergies, surgeries, and other medical data), biometric data, combinations thereof, and/or the like. The victim device data 164 can include location, make, model, IMEI, ESN, MEID, SIM, MSN, hardware specifications (e.g., processor type, memory capacity, storage capacity, and the like), software specifications (e.g., operating system and software applications installed), firmware specifications (e.g., current firmware version), radio specifications, communication capabilities (e.g., video call, VoIP, SMS, MIMS, email, and the like), battery condition (e.g., state of charge), any other data associated with the victim device 102, combinations thereof, and/or the like. The victim device data 164 can alternatively or additionally include device usage data such as, for example, call history, message history (e.g., IMESSAGE, SMS, MMS, and the like), emergency contact information, contact list/address book, application usage, social media activity, combinations thereof, and/or the like.

From operation 204, the method 200 proceeds to operation 206. At operation 206, the victim device 102 communicates the emergency event data 150 towards the emergency network 110. The victim device 102 can communicate the emergency event data 150 towards the emergency network 110 via text message, email, or an automated web posting to a well-known address such as, for example, “E911,” “911,” “E911@psap.gov,” “911@psap.gov,” “http://e911.psap.gov,” or “http://911.psap.gov,” which also could be used to automatically create a voice and/or video path for the emergency call 108. From operation 206, the method 200 proceeds to operation 208. At operation 208, the emergency event data aggregator 160 receives the emergency event data 150 communicated by the victim device 102.

From operation 208, the method 200 proceeds to operation 210. At operation 210, the emergency event 106 ensues. From operation 210, the method 200 proceeds to operation 212. At operation 212, the victim device 102 initiates an emergency call 108 directed to the emergency network 110. Prior to, during, or after the victim device 102 initiates the emergency call 108, the victim device 102 can generate and broadcast one or more emergency assistance messages 151 via BLUETOOTH or other short-range radio communications technology. In this manner, other devices, such as the bystander device 116, the landline device 138, and/or the IoT device 140, can receive notification of the emergency event 106. The emergency assistance messages 151 may include at least a portion of the victim data 162 and/or the victim device data 164 and request that this data be provided to the emergency personnel 112. The emergency assistance messages 151 may prompt for calls to be placed to the emergency network 110 on behalf of the victim 104 and grant permission to share the victim data 162 and/or the victim device data 164 with the emergency personnel 112. The victim device 102 can utilize additional or alternative communications technologies to disseminate the emergency assistance message(s) 151. For example, the victim device 102 may broadcast the emergency assistance message(s) 151 via a local WIFI network to which the victim device 102 and other devices are connected.

From operation 214, the method 200 proceeds to operation 216. At operation 216, the emergency call 108 fails. The emergency call 108 may fail for any reason. The most common reasons being network connectivity issues and battery depletion. The cause of failure is inconsequential to the performance of the method 200.

From operation 216, the method 200 proceeds to operation 218. At operation 218, the emergency event data aggregator 160 receives additional emergency event data 150 from one or more other devices. For example, the emergency event data aggregator 160 can receive the bystander data 166 and/or the bystander device data 168 from the bystander device 116, the other data source data 170 from the other data source(s) 136, the network condition data 172 from the RAN 120, the core network(s) 128, and/or other network elements (e.g., NOC and/or network probe), the landline data 174 from the landline device(s) 138, the IoT data 176 from the IoT device(s) 140, or a combination thereof.

From operation 218, the method 200 proceeds to operation 220. At operation 220, the emergency event data aggregator 160 uses the emergency event data 150 to create the emergency context 178 for the emergency personnel 112 to use in assisting the victim 104 in response to the emergency event 106. The emergency context 178 can identify a location of the emergency event 106, a type of the emergency event 106, a priority of the response needed (e.g., life-threatening vs. non-life-threatening) for handling the emergency event 106, and an identity of the victim 104 (if available). The emergency event data aggregator 160 can utilize artificial intelligence to determine the probability of each component of the emergency context 178 being a certain value. For example, a probability that the location of the victim 104 is a specific location based upon the emergency event data 150 that is related to location.

From operation 220, the method 200 proceeds to operation 222. At operation 222, the emergency event data aggregator forwards the emergency context 178 to the correct PSAP 114. For example, the location determined to be most accurate to the actual location of the victim 104 can be used to determine the correct PSAP 114 to which the emergency context 178 should be forwarded. From operation 222, the method 200 proceeds to operation 224. At operation 224, the emergency personnel 112 responds to the emergency event 106 based upon the emergency context 178. For example, a PSAP dispatcher may dispatch police, firefighter, ambulance, and/or other emergency resources to the location determined by the emergency event data aggregator 160 to help the victim 104. At operation 224, the victim device 102 may receive a notification from the emergency personnel 112 that emergency services are enroute.

From operation 224, the method 200 proceeds to operation 226. At operation 226, the method 200 can end.

Turning now to FIG. 3, an illustrative mobile device 300 and components thereof will be described. In some embodiments, the victim device 102 and/or the bystander device 116 described above with reference to FIG. 1 can be configured as and/or can have an architecture similar or identical to the mobile device 300 described herein in FIG. 3. It should be understood, however, that the victim device 102 and/or the bystander device 116 may or may not include the functionality described herein with reference to FIG. 3. While connections are not shown between the various components illustrated in FIG. 3, it should be understood that some, none, or all of the components illustrated in FIG. 3 can be configured to interact with one another to carry out various device functions. In some embodiments, the components are arranged so as to communicate via one or more busses (not shown). Thus, it should be understood that FIG. 3 and the following description are intended to provide a general understanding of a suitable environment in which various aspects of embodiments can be implemented, and should not be construed as being limiting in any way.

As illustrated in FIG. 3, the mobile device 300 can include a display 302 for displaying data. According to various embodiments, the display 302 can be configured to display network connection information, various GUI elements, text, images, video, virtual keypads and/or keyboards, messaging data, notification messages, metadata, Internet content, device status, time, date, calendar data, device preferences, map and location data, combinations thereof, and/or the like. The mobile device 300 also can include a processor 304 and a memory or other data storage device (“memory”) 306. The processor 304 can be configured to process data and/or can execute computer-executable instructions stored in the memory 306. The computer-executable instructions executed by the processor 304 can include, for example, an operating system 308, one or more applications 310, such as the victim emergency application 148 and the bystander emergency application 152, other computer-executable instructions stored in the memory 306, or the like.

The UI application can interface with the operating system 308 to facilitate user interaction with functionality and/or data stored at the mobile device 300 and/or stored elsewhere. In some embodiments, the operating system 308 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 304 to aid a user in data communications, entering/deleting data, entering and setting user IDs and passwords for device access, configuring settings, manipulating content and/or settings, multimode interaction, interacting with other applications 310, and otherwise facilitating user interaction with the operating system 308, the applications 310, and/or other types or instances of data 312 that can be stored at the mobile device 300.

The applications 310, the data 312, and/or portions thereof can be stored in the memory 306 and/or in a firmware 314, and can be executed by the processor 304. The firmware 314 also can store code for execution during device power up and power down operations. It can be appreciated that the firmware 314 can be stored in a volatile or non-volatile data storage device including, but not limited to, the memory 306 and/or a portion thereof.

The mobile device 300 also can include an input/output (“I/O”) interface 316. The I/O interface 316 can be configured to support the input/output of data such as location information, presence status information, user IDs, passwords, and application initiation (start-up) requests. In some embodiments, the I/O interface 316 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 300 can be configured to synchronize with another device to transfer content to and/or from the mobile device 300. In some embodiments, the mobile device 300 can be configured to receive updates to one or more of the applications 310 via the I/O interface 316, though this is not necessarily the case. In some embodiments, the I/O interface 316 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 316 may be used for communications between the mobile device 300 and a network device or local device.

The mobile device 300 also can include a communications component 318. The communications component 318 can be configured to interface with the processor 304 to facilitate wired and/or wireless communications with one or more networks. In some embodiments, the communications component 318 includes a multimode communications subsystem for facilitating communications via the cellular network and one or more other networks.

The communications component 318, in some embodiments, includes one or more transceivers. The one or more transceivers, if included, can be configured to communicate over the same and/or different wireless technology standards with respect to one another. For example, in some embodiments, one or more of the transceivers of the communications component 318 may be configured to communicate using GSM, CDMAONE, CDMA2000, UMTS, LTE, and various other 2G, 3G, 4G, 5G, 6G, and greater generation technology standards. Moreover, the communications component 318 may facilitate communications over various channel access methods (which may or may not be used by the aforementioned standards) including, but not limited to, TDMA, FDMA, W-CDMA, OFDM, SDMA, and the like.

In addition, the communications component 318 may facilitate data communications using GPRS, EDGE, the HSPA protocol family including HSDPA, EUL or otherwise termed HSUPA, HSPA+, and various other current and future wireless data access standards. In the illustrated embodiment, the communications component 318 can include a first transceiver (“TxRx”) 320A that can operate in a first communications mode (e.g., GSM). The communications component 318 also can include an Nth transceiver (“TxRx”) 320N that can operate in a second communications mode relative to the first transceiver 320A (e.g., UMTS). While two transceivers 320A-320N (hereinafter collectively and/or generically referred to as “transceivers 320”) are shown in FIG. 3, it should be appreciated that less than two, two, and/or more than two transceivers 320 can be included in the communications component 318.

The communications component 318 also can include an alternative transceiver (“Alt TxRx”) 322 for supporting other types and/or standards of communications. According to various contemplated embodiments, the alternative transceiver 322 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 318 also can facilitate reception from terrestrial radio networks, digital satellite radio networks, internet-based radio service networks, combinations thereof, and the like. The communications component 318 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 300 also can include one or more sensors 324. The sensors 324 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 300 may be provided by an audio I/O component 326. The audio I/O component 326 of the mobile device 300 can include one or more speakers for the output of audio signals, one or more microphones for the collection and/or input of audio signals, and/or other audio input and/or output devices.

The illustrated mobile device 300 also can include a subscriber identity module (“SIM”) system 328. The SIM system 328 can include a universal SIM (“USIM”), a universal integrated circuit card (“UICC”), e-SIM, and/or other identity devices. The SIM system 328 can include and/or can be connected to or inserted into an interface such as a slot interface 330. In some embodiments, the slot interface 330 can be configured to accept insertion of other identity cards or modules for accessing various types of networks. Additionally, or alternatively, the slot interface 330 can be configured to accept multiple subscriber identity cards. Because other devices and/or modules for identifying users and/or the mobile device 300 are contemplated, it should be understood that these embodiments are illustrative, and should not be construed as being limiting in any way.

The mobile device 300 also can include an image capture and processing system 332 (“image system”). The image system 332 can be configured to capture or otherwise obtain photos, videos, and/or other visual information. As such, the image system 332 can include cameras, lenses, charge-coupled devices (“CCDs”), combinations thereof, or the like. The mobile device 300 may also include a video system 334. The video system 333 can be configured to capture, process, record, modify, and/or store video content. Photos and videos obtained using the image system 332 and the video system 334, respectively, may be added as message content to an MMS message, email message, and sent to another device. The video and/or photo content also can be shared with other devices via various types of data transfers via wired and/or wireless communication devices as described herein.

The mobile device 300 also can include one or more location components 336. The location components 336 can be configured to send and/or receive signals to determine a geographic location of the mobile device 300. According to various embodiments, the location components 336 can send and/or receive signals from global positioning system (“GPS”) devices, assisted-GPS (“A-GPS”) devices, WI-FI/WIMAX and/or cellular network triangulation data, combinations thereof, and the like. The location component 336 also can be configured to communicate with the communications component 318 to retrieve triangulation data for determining a location of the mobile device 300. In some embodiments, the location component 336 can interface with cellular network nodes, telephone lines, satellites, location transmitters and/or beacons, wireless network transmitters and receivers, combinations thereof, and the like. In some embodiments, the location component 336 can include and/or can communicate with one or more of the sensors 324 such as a compass, an accelerometer, and/or a gyroscope to determine the orientation of the mobile device 300. Using the location component 336, the mobile device 300 can generate and/or receive data to identify its geographic location, or to transmit data used by other devices to determine the location of the mobile device 300. The location component 336 may include multiple components for determining the location and/or orientation of the mobile device 300.

The illustrated mobile device 300 also can include a power source 338. The power source 338 can include one or more batteries, power supplies, power cells, and/or other power subsystems including alternating current (“AC”) and/or direct current (“DC”) power devices. The power source 338 also can interface with an external power system or charging equipment via a power I/O component 340. Because the mobile device 300 can include additional and/or alternative components, the above embodiment should be understood as being illustrative of one possible operating environment for various embodiments of the concepts and technologies described herein. The described embodiment of the mobile device 300 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

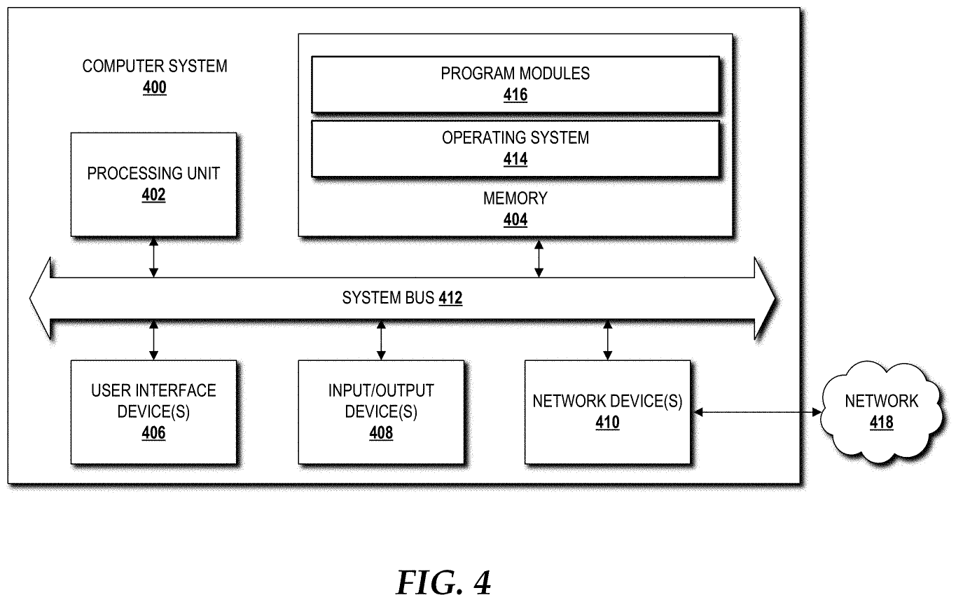

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 300 or other devices or computers described herein, such as the computer system 400 described below with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 300 in order to store and execute the software components presented herein. It is also contemplated that the mobile device 300 may not include all of the components shown in FIG. 3, may include other components that are not explicitly shown in FIG. 3, or may utilize an architecture completely different than that shown in FIG. 3.

Turning now to FIG. 4 is a block diagram illustrating a computer system 400 configured to provide the functionality in accordance with various embodiments of the concepts and technologies disclosed herein. The systems, devices, and other components disclosed herein, such as the victim device 102, the bystander device 116, the emergency event data aggregator 160, can be implemented, at least in part, using an architecture that is the same as or similar to the architecture of the computer system 400. It should be understood, however, that modification to the architecture may be made to facilitate certain interactions among elements described herein.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 404 communicates with the processing unit 402 via the system bus 412. In some embodiments, the memory 404 is operatively connected to a memory controller (not shown) that enables communication with the processing unit 402 via the system bus 412. The illustrated memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 416 may include various software and/or program modules to perform the various operations described herein such as the victim emergency application 148 and the bystander emergency application 152. The program modules 416 and/or other programs can be embodied in computer-readable media containing instructions that, when executed by the processing unit 402, perform various operations such as those described herein. According to embodiments, the program modules 416 may be embodied in hardware, software, firmware, or any combination thereof

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, PDAs, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer. In some embodiments, the I/O devices 408 can be used for manual controls for operations to exercise under certain emergency situations.

The network devices 410 enable the computer system 400 to communicate with other networks or remote systems via a network 418, such as the RAN 120, the core network 128, the other network(s) 134, and/or the emergency network 110. Examples of the network devices 410 include, but are not limited to, a modem, a radio frequency (“RF”) or infrared (“IR”) transceiver, a telephonic interface, a bridge, a router, or a network card. The network 418 may be or may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 418 may be or may include a wired network such as, but not limited to, a Wide Area Network (“WAN”), a wired Personal Area Network (“PAN”), or a wired Metropolitan Area Network (“MAN”).

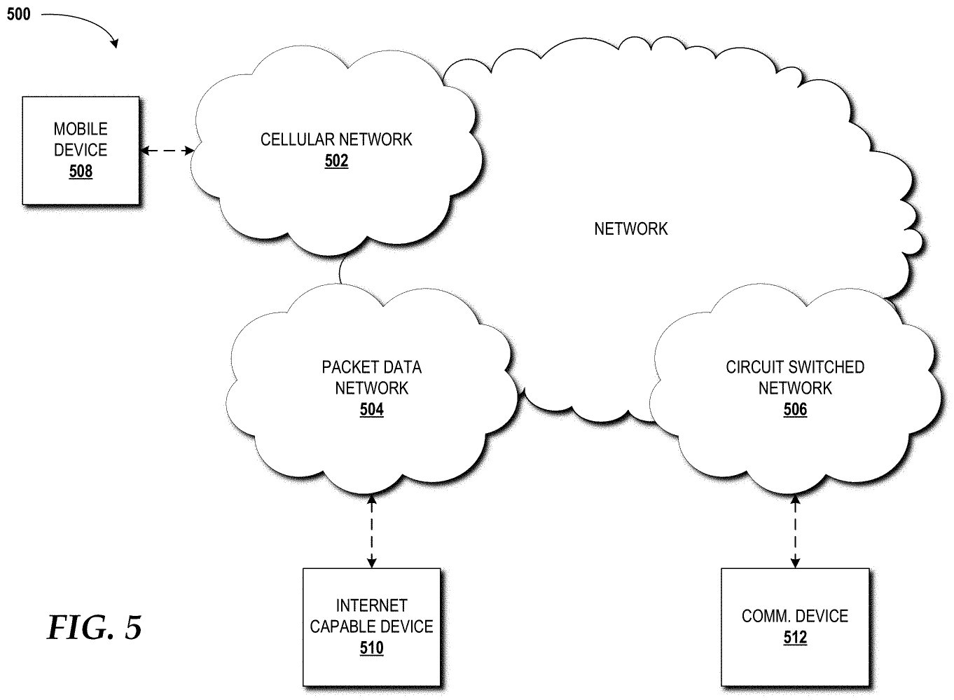

Turning now to FIG. 5, details of a network 500 are illustrated, according to an illustrative embodiment. In some embodiments, the network 500 can include the RAN 120, the core network 128, the other network(s) 134, and/or the emergency network 110. The illustrated network 500 includes a cellular network 502, a packet data network 504, for example, the Internet, and a circuit switched network 506, for example, a public switched telephone network (“PSTN”). The cellular network 502 includes various components such as, but not limited to, base transceiver stations (“BTSs”), NBs or eNBs, combination eNB/gNB (e.g., the eNB/gNB 126), base station controllers (“BSCs”), radio network controllers (“RNCs”), mobile switching centers (“MSCs”), MMEs, short message service centers (“SMSCs”), multimedia messaging service centers (“MMSCs”), home location registers (“HLRs”), HSSs, VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, the victim device 102, the bystander device 116, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards such as LTE, or the like, as well as evolved and future mobile standards.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 504 includes various hardware and software for providing circuit switched communications. The circuit switched network 506 may include, or may be, what is often referred to as a plain old telephone system (“POTS”). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, the victim device 102, the bystander device 116, the IoT device(s) 140, the landline device(s) 138, the emergency event data aggregator 160, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network is used to refer broadly to any combination of the networks 502, 504, 506 shown in FIG. 5. It should be appreciated that substantially all of the functionality described with reference to RAN 120, the core networks 128, and/or the other networks 134 can be performed, at least in part, by the cellular network 502, the packet data network 504, and/or the circuit switched network 506, alone or in combination with other networks, network elements, and the like.

Turning now to FIG. 6, a block diagram illustrating an example virtualized cloud architecture 600 and components thereof will be described, according to an exemplary embodiment. In some embodiments, the virtualized cloud architecture 600 can be utilized to implement, at least in part, the RAN 120, the core networks 128, the other network(s) 134, the emergency network 110, the PSAPs 114, the emergency event data aggregator 160, or portions thereof. The virtualized cloud architecture 600 is a shared infrastructure that can support multiple services and network applications. The illustrated virtualized cloud architecture 600 includes a hardware resource layer 602, a control layer 604, a virtual resource layer 606, and an application layer 608 that work together to perform operations as will be described in detail herein.

The hardware resource layer 602 provides hardware resources, which, in the illustrated embodiment, include one or more compute resources 610, one or more memory resources 612, and one or more other resources 614. The compute resource(s) 610 can include one or more hardware components that perform computations to process data, and/or to execute computer-executable instructions of one or more application programs, operating systems, and/or other software. The compute resources 610 can include one or more central processing units (“CPUs”) configured with one or more processing cores. The compute resources 610 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 610 can include one or more discrete GPUs. In some other embodiments, the compute resources 610 can include CPU and GPU components that are configured in accordance with a co-processing CPU/GPU computing model, wherein the sequential part of an application executes on the CPU and the computationally-intensive part is accelerated by the GPU. The compute resources 610 can include one or more system-on-chip (“SoC”) components along with one or more other components, including, for example, one or more of the memory resources 612, and/or one or more of the other resources 614. In some embodiments, the compute resources 610 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 610 can be or can include one or more hardware components architected in accordance with an advanced reduced instruction set computing (“RISC”) machine (“ARM”) architecture, available for license from ARM HOLDINGS. Alternatively, the compute resources 610 can be or can include one or more hardware components architected in accordance with an x86 architecture, such an architecture available from INTEL CORPORATION of Mountain View, Calif., and others. Those skilled in the art will appreciate the implementation of the compute resources 610 can utilize various computation architectures, and as such, the compute resources 610 should not be construed as being limited to any particular computation architecture or combination of computation architectures, including those explicitly disclosed herein.

The memory resource(s) 612 can include one or more hardware components that perform storage operations, including temporary or permanent storage operations. In some embodiments, the memory resource(s) 612 include volatile and/or non-volatile memory implemented in any method or technology for storage of information such as computer-readable instructions, data structures, program modules, or other data disclosed herein.

Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 610.

The other resource(s) 614 can include any other hardware resources that can be utilized by the compute resources(s) 610 and/or the memory resource(s) 612 to perform operations described herein. The other resource(s) 614 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more virtual machine monitors (“VMMs”) 616A-616N (also known as “hypervisors”; hereinafter “VMMs 616”) operating within the control layer 604 to manage one or more virtual resources that reside in the virtual resource layer 606. The VMMs 616 can be or can include software, firmware, and/or hardware that alone or in combination with other software, firmware, and/or hardware, manages one or more virtual resources operating within the virtual resource layer 606.

The virtual resources operating within the virtual resource layer 606 can include abstractions of at least a portion of the compute resources 610, the memory resources 612, the other resources 614, or any combination thereof. These abstractions are referred to herein as virtual machines (“VMs”). In the illustrated embodiment, the virtual resource layer 606 includes VMs 618A-618N (hereinafter “VMs 618”). Each of the VMs 618 can execute one or more applications 620A-620N in the application layer 608.

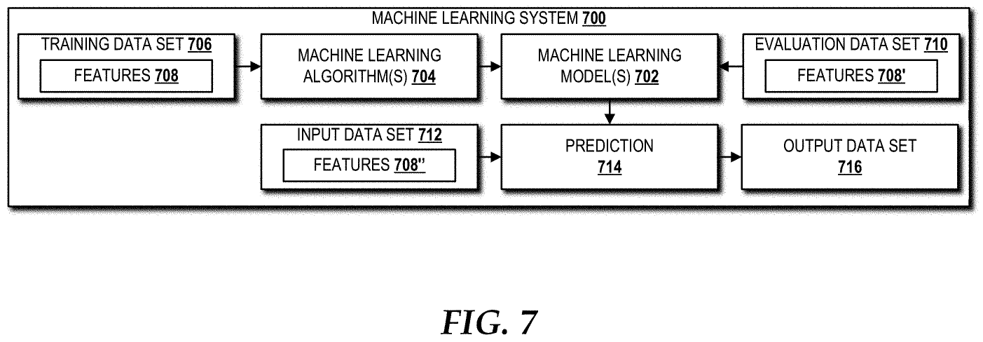

Turning now to FIG. 7, a machine learning system 700 capable of implementing aspects of the embodiments disclosed herein will be described. In some embodiments, the emergency event data aggregator 160 can implement or otherwise utilize a machine learning system such as the machine learning system 700. The illustrated machine learning system 700 includes one or more machine learning models 702. The machine learning models 702 can include supervised and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 706 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 707 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

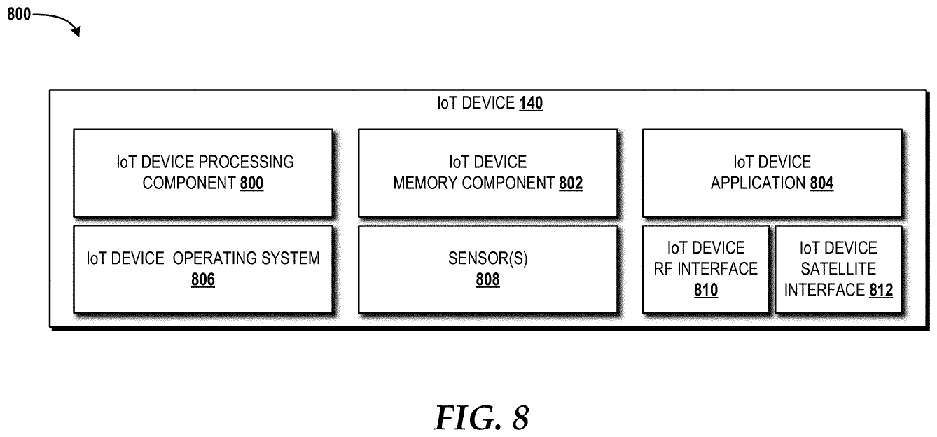

Turning now to FIG. 8, a block diagram illustrating aspects of an example architecture 800 for an IoT device 140 and components thereof capable of implementing aspects of the embodiments presented herein. The illustrated IoT device 140 includes an IoT device processing component 800, an IoT device memory component 802, an IoT device application 804, an IoT device operating system 806, one or more IoT device sensors 808, an IoT device RF interface 810, and an IoT device satellite interface 812. FIG. 8 will be described with additional reference to FIG. 1.

The IoT device processing component 800 (also referred to herein as a “processor”) can include one or more hardware components that perform computations to process data, and/or to execute computer-executable instructions of one or more application programs such as the IoT device application 804, one or more operating systems such as the IoT device operating system 806, and/or other software. The IoT device processing component 800 can include one or more CPUs configured with one or more processing cores. The IoT device processing component 800 can include one or more GPU configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the IoT device processing component 800 can include one or more discrete GPUs. In some other embodiments, the IoT device processing component 800 can include CPU and GPU components that are configured in accordance with a co-processing CPU/GPU computing model, wherein the sequential part of an application executes on the CPU and the computationally-intensive part is accelerated by the GPU. The IoT device processing component 800 can include one or more SoC components along with one or more other components illustrated as being part of the IoT device 140, including, for example, the IoT device memory component 802. In some embodiments, the IoT device processing component 800 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more OMAP SoCs, available from TEXAS INSTRUMENTS of Dallas, Tex.; one or more customized versions of any of the above SoCs; and/or one or more proprietary SoCs. The IoT device processing component 800 can be or can include one or more hardware components architected in accordance with an ARM architecture, available for license from ARM HOLDINGS of Cambridge, United Kingdom. Alternatively, the IoT device processing component 800 can be or can include one or more hardware components architected in accordance with an x86 architecture, such an architecture available from INTEL CORPORATION of Mountain View, Calif., and others. Those skilled in the art will appreciate the implementation of the IoT device component 800 can utilize various computation architectures, and as such, the IoT device processing component 800 should not be construed as being limited to any particular computation architecture or combination of computation architectures, including those explicitly disclosed herein.

The IoT device memory component 802 can include one or more hardware components that perform storage operations, including temporary or permanent storage operations. In some embodiments, the IoT device memory component 802 include volatile and/or non-volatile memory implemented in any method or technology for storage of information such as computer-readable instructions, data structures, program modules, the IoT device operating system 806, the IoT device application 804, or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the IoT device processing component 800.

The IoT device application 804 can be executed by the IoT device processing component 800 to perform operations such as collecting the IoT data 176 and providing the IoT data 176 to the emergency network 110. The IoT device application 804 can execute on top of the IoT device operating system 806. In some embodiments, the IoT device application 804 is provided as firmware.

The IoT device operating system 806 can control the operation of the IoT device 140. In some embodiments, the IoT device operating system 806 includes the functionality of the IoT device application 804. The IoT device operating system 806 can be executed by the IoT device processing component 800 to cause the IoT device 140 to perform various operations. The IoT device operating system 806 can include a member of the SYMBIAN OS family of operating systems from SYMBIAN LIMITED, a member of the WINDOWS OS, WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems or a member of the OS X family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The sensor(s) 808 can include any sensor type or combination of sensor types utilizing any known sensor technology that is capable of detecting one or more characteristics of an environment, such as an observed area, in which the IoT device 140 is deployed. More particularly, the sensor(s) 808 can include, but are not limited to, the environmental sensors described herein above, lighting control sensor, appliance control sensor, security sensor, alarm sensor, medication dispenser sensor, entry/exit detector sensor, video sensor, camera sensor, alarm sensor, motion detector sensor, door sensor, window sensor, window break sensor, outlet control sensor, vibration sensor, occupancy sensor, orientation sensor, water sensor, water leak sensor, flood sensor, temperature sensor, humidity sensor, smoke detector sensor, carbon monoxide detector sensor, doorbell sensor, dust detector sensor, air quality sensor, light sensor, gas sensor, fall detector sensor, weight sensor, blood pressure sensor, IR sensor, HVAC sensor, smart home sensor, thermostats, other security sensors, other automation sensors, other environmental monitoring sensors, other healthcare sensors, multipurpose sensor that combines two or more sensors, the like, and/or combinations thereof.

The IoT device RF interface 810 can include an RF transceiver or separate receiver and transmitter components. The IoT device RF interface 810 can include one or more antennas and one or more RF receivers for receiving RF signals from and one or more RF transmitters for sending RF signals to one or more networks, such as the RAN 120 via the IoT gateway 146. The IoT device satellite interface 812 can be an interface to a satellite communications system (not shown).

It should be understood that some implementations of the IoT device 140 can include multiple IoT device processing components 800, multiple IoT device memory components 802, multiple IoT device applications 804, multiple IoT device operating systems 806, multiple IoT device RF interfaces 810, multiple IoT device satellite interfaces 812, or some combination thereof. Thus, the illustrated embodiment should be understood as being illustrative, and should not be construed as being limiting in any way.

Based on the foregoing, it should be appreciated that concepts and technologies directed to context-enhanced emergency service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
executing, by a victim device comprising a processor, a victim emergency application;
preemptively collecting, by the victim emergency application, emergency event data associated with a victim of an emergency event before the emergency event occurs, wherein the victim is associated with the victim device;
communicating, by the victim device, the emergency event data towards an emergency network; and
initiating, by the victim device, an emergency call directed to the emergency network, wherein the emergency call is placed by the victim in response to the emergency event, and wherein the emergency call fails.

2. The method of claim 1, wherein the emergency event data comprises victim data associated with the victim, victim device data associated with the victim device, or a combination of the victim data and the victim device data.

3. The method of claim 1, further comprising broadcasting, by the victim device, an emergency assistance message to at least one device.

4. The method of claim 3, wherein the emergency assistance message prompts the at least one device to provide additional emergency event data to the emergency network; and wherein the at least one device comprises:
a bystander device associated with a bystander of the emergency event;
an Internet of Things device; or
a landline device.

5. The method of claim 1, further comprising determining, by an emergency event data aggregator, an emergency context based, at least in part, upon the emergency event data.

6. The method of claim 5, wherein the emergency context comprises a location of the victim.

7. The method of claim 6, further comprising forwarding, by the emergency event data aggregator, the emergency context to a public safety answering point that is determined based, at least in part, upon the emergency event data, to be correct for the location of the victim, whereby emergency personnel at the public safety answering point respond to the emergency event based upon the emergency context.

8. A system comprising:
a victim device comprising a processor; and a memory comprising instructions for a victim device application that, when executed by the processor, cause the processor to perform operations comprising
preemptively collecting emergency event data associated with a victim of an emergency event before the emergency event occurs, wherein the victim is associated with the victim device,
communicating the emergency event data towards an emergency network, and
initiating an emergency call directed to the emergency network, wherein the emergency call is placed by the victim in response to the emergency event, and wherein the emergency call fails.

9. The system of claim 8, wherein the emergency event data comprises victim data associated with the victim, victim device data associated with the victim device, or a combination of the victim data and the victim device data.

10. The system of claim 8, wherein the operations further comprise broadcasting an emergency assistance message to an additional device.

11. The system of claim 10, wherein the additional device comprises a bystander device associated with a bystander of the emergency event, an Internet of Things device, or a landline device; wherein the emergency assistance message prompts the additional device to provide additional emergency event data to the emergency network.

12. The system of claim 8, further comprising an emergency event data aggregator; wherein the emergency event data aggregator performs operations comprising determining an emergency context based, at least in part, upon the emergency event data.

13. The system of claim 12, wherein the emergency context comprises a location of the victim.

14. The system of claim 13, wherein the emergency event data aggregator performs operations further comprising forwarding the emergency context to a public safety answering point that is determined based, at least in part, upon the emergency event data, to be correct for the location of the victim, whereby emergency personnel at the public safety answering point respond to the emergency event based upon the emergency context.

15. A computer-readable storage medium comprising computer-executable instructions that, when executed by a processor of a victim device, cause the processor to perform operations comprising:
preemptively collecting emergency event data associated with a victim of an emergency event before the emergency event occurs, wherein the victim is associated with the victim device;
communicating the emergency event data towards an emergency network; and
initiating an emergency call directed to the emergency network, wherein the emergency call is placed by the victim in response to the emergency event, and wherein the emergency call fails.

16. The computer-readable storage medium of claim 15, wherein the emergency event data comprises victim data associated with the victim, victim device data associated with the victim device, or a combination of the victim data and the victim device data.

17. The computer-readable storage medium of claim 15, wherein the operations further comprise broadcasting an emergency assistance message to an additional device comprising a bystander device associated with a bystander of the emergency event, an Internet of Things device, or a landline device.

18. The computer-readable storage medium of claim 17, wherein the emergency assistance message prompts the additional device to provide additional emergency event data to the emergency network.

19. The computer-readable storage medium of claim 15, wherein communicating the emergency event data towards the emergency network comprises communicating the emergency event data towards the emergency network, whereby an emergency event data aggregator determines an emergency context based, at least in part, upon the emergency event data, wherein the emergency context comprises a location of the victim.

20. The computer-readable storage medium of claim 19, wherein the operations further comprise receiving a notification from a public safety answering point determined by the emergency event data aggregator to be correct for the location of the victim, wherein the notification informs the victim that emergency personnel are enroute to the location.
